(19) United States
(12) Patent Application Publication
(10) Pub. No.: US 2016/0022047 A1
(43) Pub. Date: Jan. 28, 2016

(54) CHAIR HAVING A REMINDER FUNCTION

(71) Applicant: Yao-Chuan WU, Chiayi Hsien (TW)

(72) Inventor: Yao-Chuan WU, Chiayi Hsien (TW)

(21) Appl. No.: 14/337,548

(22) Filed: Jul. 22, 2014

(51) Int. Cl. A47C 7/62; G08B 21/04; A47C 7/54

(52) U.S. Cl. CPC A47C 7/62; A47C 7/54; G08B 21/0461

(57) ABSTRACT

A chair having a reminder function comprises a chair body, a reminder, and a sitting posture determining device, wherein the chair body has a seat and a backrest, wherein the sitting posture determining device has a seat detector, a backrest detector, and a microcontroller. The seat detector is mounted in the seat for detecting whether a user is sitting on the seat or not; the backrest detector is mounted in the backrest for detecting whether the user is leaning against the backrest; the microcontroller is electrically connected to the seat detector, the backrest detector and the reminder, and determines whether to actuate the reminder to generate a reminding notification based on the detecting result of the seat detector and the backrest detector for reminding the user to adjust the sitting posture or timely move the body.

### BACKGROUND OF THE INVENTION

1. Field of the Invention

The present invention relates to a chair, especially to a chair that has a reminder function.

2. Description of the Prior Arts

With a sedentary lifestyle, contemporary people often take a long time sitting on a chair for work, leisure, resting, and so on. However, if the sitting posture is incorrect or lasts for too long, it may hurt people's health. For instance, if the user's waist is not fully supported by the backrest when the user is sitting on the chair, negative impacts such as muscle strain and lumbar pain may occur, along with frequent fatigue. Besides, excessive duration of the sitting posture also hurts people's health, leading to obesity, joint rigidity, partial paralysis, and other adverse consequences.

### SUMMARY OF THE INVENTION

As above described, incorrect posture or long-time sitting leads to negative impact on health. The present invention provides a chair having a reminder function, which can provide a reminding notification for a user when the sitting posture is not correct or has lasted too long.

The objective of the invention is to provide a chair, the chair comprising: a chair body, a reminder and a sitting posture determining device, wherein the chair body comprising a seat and a backrest; and the sitting posture determining device mounted in the chair body. The sitting posture determining device comprising a seat detector, a backrest detector, and a microcontroller, wherein the sear detector is mounted in the seat and detecting whether a user is sitting on the seat; the backrest detector is mounted in the backrest and detecting whether the user is leaning against the backrest; the microcontroller electrically connected to the seat detector, the backrest detector, and the reminder; wherein the microcontroller determines whether to actuate the reminder to generate a reminding notification based on a detecting result of the seat detector and the backrest detector.

Preferably, the microcontroller comprises multiple inputs electrically connected to the seat detector and the backrest detector respectively through wires.

Preferably, the backrest detector is electrically connected to a wireless transmitter, the microcontroller is electrically connected to a wireless receiver, and the wireless transmitter and the wireless receiver are connected to each other for transmitting the reminding notification.

Preferably, the microcontroller is connected to a remote control, and the remote control is for actuating or stopping operation of the microcontroller.

Preferably, the microcontroller is connected to a master switch.

Preferably, the reminder is connected to the microcontroller through a transmission line and a universal serial bus (USB) interface.

Preferably, the reminder is connected to a speaker of the microcontroller via a wire.

More preferably, the chair body comprises two armrests mounted on both sides of the seat, and the master switch is mounted at any one of the armrests.

Preferably, the seat detector and the backrest detector are normally open micro switches.

The present invention of the sitting posture determining device is used for determining whether the user is sitting on the chair in a correct posture or not. When the sitting posture of the user is incorrect, such as sitting on the seat without leaning against the backrest or sitting on the chair body for too long, the microcontroller actuates the reminder to generate the reminding notification to the user. The user can timely adjust the sitting posture to lean against the backrest or get up from the seat to move the body based on the reminding notification. Therefore, if the user does not lean against the backrest or sits too long when using the present invention, it can remind the user to adjust the sitting posture or timely move the body for advantage of health.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a chair having a reminder function of the present invention.

FIG. 2 is a function block diagram of the chair of the present invention.

FIG. 3 is another function block diagram of the chair of the present invention.

FIG. 4 is a flow diagram of determining sitting posture of the present invention.

FIG. 5 is a schematic view showing a reminder of the chair of the present invention displaying a reminding notification.

FIG. 6 is another schematic view showing the reminder displaying a reminding notification.

### DETAILED DESCRIPTION OF THE PREFERRED EMBODIMENTS

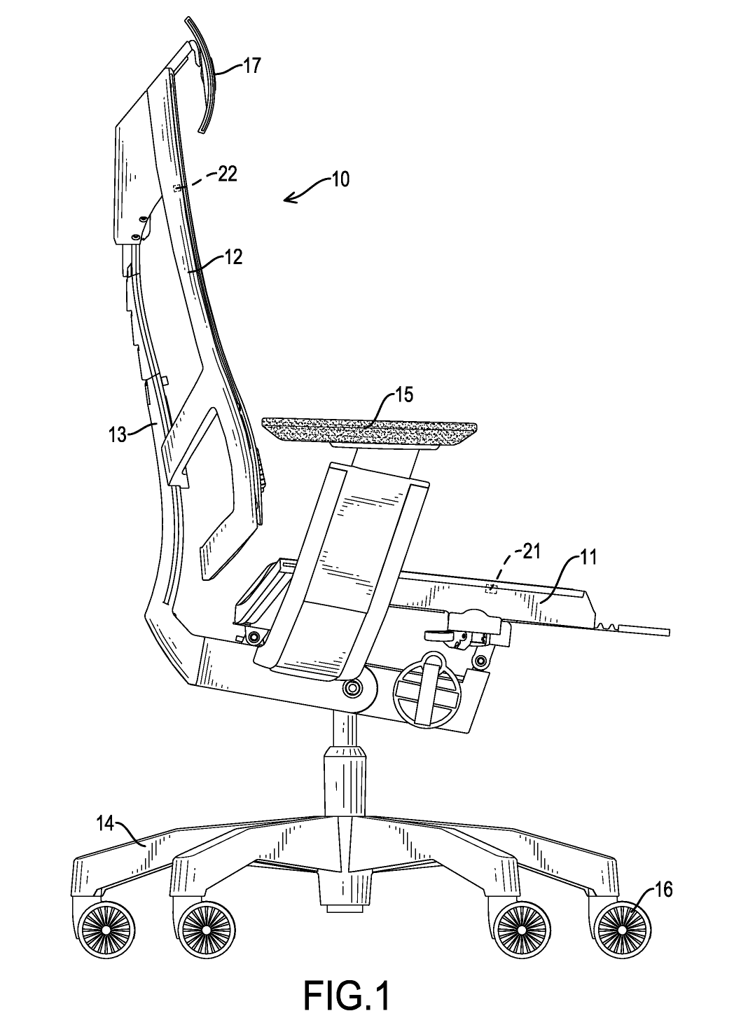

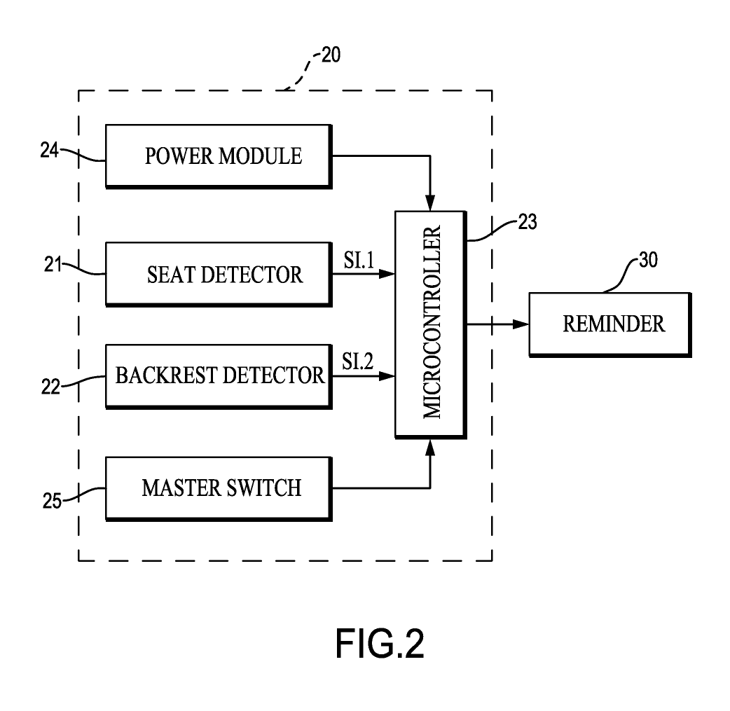

With reference to FIG. 1 and FIG. 2, a preferred embodiment of the present invention comprises a chair body 10, a sitting posture determining device 20, and a reminder 30.

The chair body 10 comprises a seat 11, a backrest 12, and a back support 13 connected between the seat 11 and the backrest 12. The chair body 10 has a base 14 connected to the bottom of the seat 11, and the chair body 10 has two armrests 15 respectively on two sides of the seat 11. Multiple casters 16 are mounted at the bottom of the base 14 of the chair body 10. A headrest 17 is mounted at the top of the backrest 12 of the chair body 10. When a user sits on the chair body 10, the headrest 17 can support the user's head. The chair body 10 can be easily moved by the user with the casters 16.

The determining device 20 is mounted on the chair body 10, which comprises a seat detector 21, a backrest detector 22, a microcontroller 23 and a power module 24. The seat detector 21 and the backrest detector 22 are mounted on the seat 11 and the backrest 12 respectively. Preferably, the backrest detector 22 can be mounted at the middle upper area of the backrest 12 corresponding to the upper back of the user, particularly human body. Surfaces of the seat 11 and the backrest 12 respectively have a wrapping layer being a mesh or made of leather. The seat detector 21 and the backrest detector 22 are respectively disposed at an inner side of the wrapping layers. The power module 24 comprises a mounting seat having a battery installed inside the mounting seat, wherein the mounting seat is mounted in the seat 11.

The seat detector 21 generates a seat detection signal SI.1 when the user is sitting on the seat 11. The backrest detector 22 generates a backrest detection signal SI.2 when the user is leaning against the backrest 12. The microcontroller 23 comprises multiple inputs electrically connected to the seat detector 21 and the backrest detector 22 respectively through wires, receiving the seat detection signal SI.1 and the backrest detection signal SI.2. The microcontroller 23 comprises an output electrically connected to the reminder 30. The seat detector 21 and the backrest detector 22 are normally open micro switches. When the user sits on the seat 11, the seat detector 21 can be turned on by the pressing the micro switch. The seat detector 21 can generate a turn-on signal as the seat detection signal SI.1; similarly, when the user leaning against the backrest 12, the backrest 12 can be turned on by pressing the micro switch. The backrest 12 can generate a turn-on signal as the backrest detection signal SI.2.

The microcontroller 23 can be electrically connected to a master switch 25, which is located at a position the user can easily touch. For example, the master switch 25 is mounted at any one of the armrests 15 of the chair body 10 for actuating or stopping the operation of the microcontroller 23 according to the user's need, such as stopping the operation of the microcontroller 23 during a meeting. In addition to actuating or stopping the operation of the microcontroller 23 through the master switch 25, the microcontroller 23 can also be connected with a remote control (not shown in the drawings) for the user to actuate or stop the operation of the microcontroller 23.

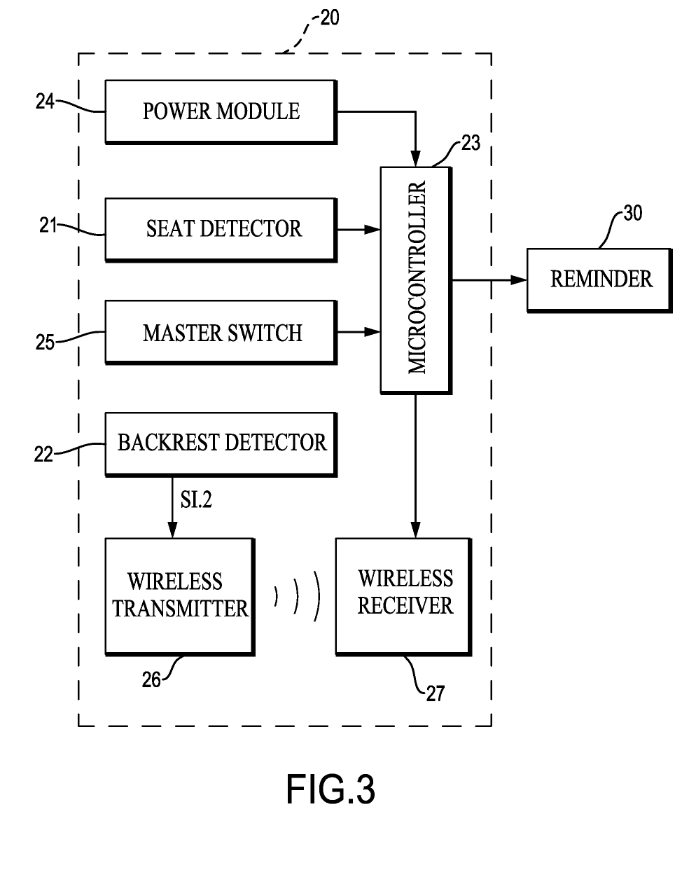

As shown in FIG. 3, in a second embodiment, the microcontroller 23 can be wirelessly connected to the seat detector 21 or the backrest detector 22. The backrest detector 22 can be electrically connected to a wireless transmitter 26, and the microcontroller 23 has an input for electrically connecting to a wireless receiver 27. The wireless receiver 27 and the wireless transmitter 26 are connected to each other for transmitting the reminding notification. When the backrest detector 22 generates the backrest detection signal SI.2, the backrest detection signal SI.2 can be transmitted from the wireless receiver 27 and the wireless transmitter 26 to the microcontroller 23 through wireless transmission. Therefore, in the second preferred embodiment, the wire connecting between the microcontroller 23 and the seat detector 21 can be eliminated.

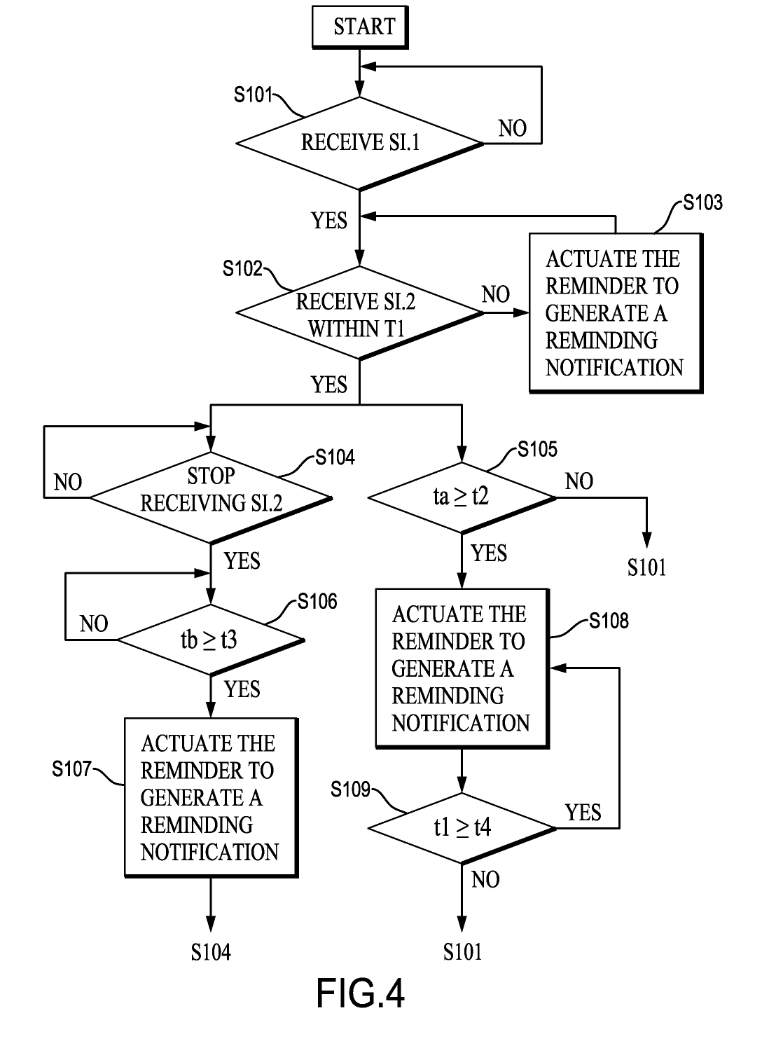

Operation of the sitting posture determining device 20 is described as follows. As shown in FIG. 1, FIG. 2 and FIG. 4, when the microcontroller 23 receives the seat detection signal SI.1, the microcontroller 23 determines whether the backrest detection signal SI.2 is also received within a first time period t1 or not (S102), wherein the first time period t1 is approximately 1 minute. If not, it represents that the user only sits on the seat 11 but does not lean against the backrest 12, which is regarded as an incorrect sitting posture, and the microcontroller 23 will actuate the reminder 30 to generate a reminding notification (S103) until the microcontroller 23 receives the backrest detection signal SI.2. For example, the reminder 30 is a speaker connected to the microcontroller 23 through the wire and actuates the reminder 30 to repeatedly generate a short “beep” sound as the reminding notification. When the microcontroller 23 receives the backrest detection signal SI.2 within the first time period t1, it represents that the user sits on the seat 11 and leans against the backrest 12 at the same time, the microcontroller 23 will count down when receiving both the seat detection signal SI.1 and the backrest detection signal SI.2, and determines whether a duration time period ta of the received seat detection signal SI.1 reaches a second time period t2 (S105) or not, wherein the second time period t2 is approximately 1 to 2 hours.

When the microcontroller 23 stops receiving the backrest detection signal SI.2 (S104), the microcontroller 23 further determines whether a duration time period tb of discontinuation of the backrest detection signal SI.2 reaches a third time period t3 (S106) or not, wherein the third time period t3 is approximately 1 minute. If yes, it represents that the user still does not lean against the backrest 12, and the microcontroller 23 will actuate the reminder 30 to generate a reminding notification (S107), for example, the microcontroller 23 actuates the reminder 30 to repeatedly generate a short “beep” sound as the reminding notification until the microcontroller 23 receives the backrest detection signal SI.2 again.

When ta<t2 (S105), it represents that the user leaves the seat 11 within the third time period t3, and the microcontroller 23 re-performs S101. On the contrary, when ta≧t2, it represents that the user has sat on the seat 11 for a long time, needing to move the body, and the microcontroller 23 actuates the reminder 30 to generate a reminding notification (S108), such as actuating the reminder 30 to repeatedly play a voice “move around” as the reminding notification, which can be lasted for a while, such as 10 seconds.

When the microcontroller 23 generates the reminding notification, the microcontroller 23 further determines whether the duration time period ta of the received seat detection signal SI.1 reaches a fourth time period t4 (S109) or not, wherein the fourth time period t4 is approximately 10 to 30 minutes. If yes, the microcontroller 23 re-performs S108, actuating the reminder 30 to generate the reminding notification in order to repeatedly remind the user. If the microcontroller 23 determines that the duration time period ta of the received seat detection signal SI.1 does not reach the fourth time period t4, it represents that the user has left the seat 11 within the fourth time period t4, and the microcontroller 23 re-performs S101.

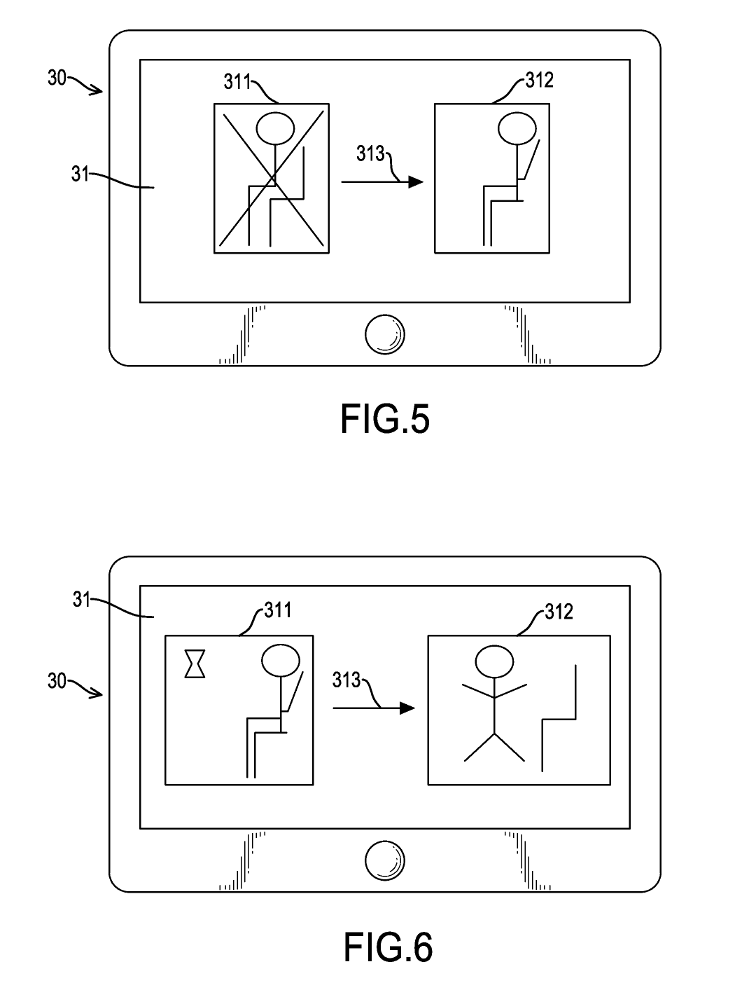

In order to enhance the effect of the present invention, the reminder 30 can be a smart phone, a tablet PC, a notebook or other electronic devices connected with the microcontroller 23 through a transmission line, a USB interface or wireless transmission interface, such as Bluetooth. As shown in FIG. 1 and FIG. 5, the reminder 30 is a tablet PC having a screen 31. When the microcontroller 23 does not receive the backrest detection signal SI.2 within the first time period t1(S102), the screen 31 of the tablet PC will display a first diagram 311 and a second diagram 312. The first diagram 311 indicates the status that the user does not lean against the backrest 12, the second diagram 312 indicates the status that the user leans against the backrest 12, and the arrow symbol 313 points from the first diagram 311 to the second diagram 312 indicating that the user should adjust sitting posture from an incorrect posture to a correct posture, wherein the tablet PC also can repeatedly generate a short “beep” sound as reminding sound, or generate a vibration to remind the user to adjust the sitting posture.

Similarly, as shown in FIG. 1 and FIG. 6, the reminder 30 is a tablet PC. The screen 31 of the tablet PC displays a first diagram311 and a second diagram 312 (S108). The first diagram 311 indicates the status that the user has sat on the chair body 10 for a long time, the second diagram 312 indicates the status that the user leaves the chair body 10, and the arrow symbol 313 points from the first diagram 311 to the second diagram 312 indicating that the user should leave the chair body 10 to move the body, wherein the tablet PC can also play a reminding voice “move around”, or generate a vibration to remind the user to leave the chair body 10 and move the body.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A chair having a reminder function, the chair comprising:
a chair body comprising a seat and a backrest;
a reminder; and
a sitting posture determining device mounted in the chair body, comprising:
a seat detector mounted in the seat;
a backrest detector mounted in the backrest; and
a microcontroller electrically connected to the seat detector, the backrest detector, and the reminder; wherein the microcontroller determines whether to actuate the reminder to generate a reminding notification based on a detecting result of the seat detector and the backrest detector.

2. The chair according to claim 1, wherein the microcontroller comprises multiple inputs electrically connected to the seat detector and the backrest detector respectively through wires.

3. The chair according to claim 1, wherein the backrest detector is electrically connected to a wireless transmitter, the microcontroller is electrically connected to a wireless receiver, and the wireless transmitter and the wireless receiver are connected to each other for transmitting the reminding notification.

4. The chair according to claim 1, wherein the microcontroller is connected to a remote control, and the remote control is for actuating or stopping operation of the microcontroller.

5. The chair according to claim 2, wherein the microcontroller is connected to a remote control, and the remote control is for actuating or stopping operation of the microcontroller.

6. The chair according to claim 3, wherein the microcontroller is connected to a remote control, and the remote control is for actuating or stopping operation of the microcontroller.

7. The chair according to claim 1, wherein the microcontroller is connected to a master switch.

8. The chair according to claim 2, wherein the microcontroller is connected to a master switch.

9. The chair according to claim 3, wherein the microcontroller is connected to a master switch.

10. The chair according to claim 1, wherein the reminder is connected to the microcontroller through a transmission line and a universal serial bus (USB) interface.

11. The chair according to claim 2, wherein the reminder is connected to the microcontroller through a transmission line and a USB interface.

12. The chair according to claim 3, wherein the reminder is connected to the microcontroller through a transmission line and a USB interface.

13. The chair according to claim 1, wherein the reminder is connected to a speaker of the microcontroller via a wire.

14. The chair according to claim 2, wherein the reminder is connected to a speaker of the microcontroller via a wire.

15. The chair according to claim 3, wherein the reminder is connected to a speaker of the microcontroller via a wire.

16. The chair according to claim 7, wherein the chair body comprises two armrests mounted on both sides of the seat, and the master switch is mounted at any one of the armrests.

17. The chair according to claim 8, wherein the chair body comprises two armrests mounted on both sides of the seat, and the master switch is mounted at any one of the armrests.

18. The chair according to claim 9, wherein the chair body comprises two armrests mounted on both sides of the seat, and the master switch is mounted at any one of the armrests.

19. The chair according to claim 1, wherein the seat detector and the backrest detector are normally open micro switches.
